(19) United States
(12) Patent Application Publication
(10) Pub. No.: US 2026/0067867 A1
(43) Pub. Date: Mar. 5, 2026

(54) TECHNIQUES FOR SELECTING RESOURCE FOR MULTIPLE CONSECUTIVE SLOT TRANSMISSION

(71) Applicant: QUALCOMM Incorporated, San Diego, CA (US)

(72) Inventors: Shaozhen GUO, Beijing (CN); Changlong XU, Beijing (CN); Jing SUN, San Diego, CA (US); Chih-Hao LIU, San Diego, CA (US); Giovanni CHISCI, San Diego, CA (US); Luanxia YANG, Beijing (CN); Siyi CHEN, Beijing (CN); Xiaoxia ZHANG, San Diego, CA (US); Hao XU, Beijing (CN)

(21) Appl. No.: 19/104,557

(22) PCT Filed: Nov. 4, 2022
(86) PCT No.: PCT/CN2022/129800

§ 371 Date: Feb. 18, 2025

(51) Int. Cl. H04W 72/02; H04W 72/0446; H04W 72/25

(52) U.S. Cl. CPC H04W 72/02; H04W 72/0446; H04W 72/25

(57) ABSTRACT

Various aspects of the present disclosure generally relate to wireless communication. In some aspects, a user equipment (UE) may identify one or more sets of parameters for resource selection for a multiple consecutive slot transmission (MCST). The UE may identify a resource selection window based at least in part on the one or more sets of parameters. The UE may select a set of candidate multi-slot resources in accordance with the resource selection window and based at least in part on a threshold associated with the MCST. The UE may perform a transmission associated with at least one of the set of candidate multi-slot resources. Numerous other aspects are described.

### FIELD OF THE DISCLOSURE

Aspects of the present disclosure generally relate to wireless communication and to techniques and apparatuses for selecting a resource for multiple consecutive slot transmission (MCST).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include identifying one or more sets of parameters for resource selection for a multiple consecutive slot transmission (MCST). The method may include identifying a resource selection window based at least in part on the one or more sets of parameters. The method may include selecting a set of candidate multi-slot resources in accordance with the resource selection window and based at least in part on a threshold associated with the MCST. The method may include performing a transmission associated with at least one of the set of candidate multi-slot resources.

Some aspects described herein relate to a UE for wireless communication. The UE may include a memory and one or more processors coupled to the memory. The one or more processors may be configured to identify one or more sets of parameters for resource selection for a MCST. The one or more processors may be configured to identify a resource selection window based at least in part on the one or more sets of parameters. The one or more processors may be configured to select a set of candidate multi-slot resources in accordance with the resource selection window and based at least in part on a threshold associated with the MCST. The one or more processors may be configured to perform a transmission associated with at least one of the set of candidate multi-slot resources.

Some aspects described herein relate to a non-transitory computer-readable medium that stores a set of instructions for wireless communication by a UE. The set of instructions, when executed by one or more processors of the UE, may cause the UE to identify one or more sets of parameters for resource selection for a MCST. The set of instructions, when executed by one or more processors of the UE, may cause the UE to identify a resource selection window based at least in part on the one or more sets of parameters. The set of instructions, when executed by one or more processors of the UE, may cause the UE to select a set of candidate multi-slot resources in accordance with the resource selection window and based at least in part on a threshold associated with the MCST. The set of instructions, when executed by one or more processors of the UE, may cause the UE to perform a transmission associated with at least one of the set of candidate multi-slot resources.

Some aspects described herein relate to an apparatus for wireless communication. The apparatus may include means for identifying one or more sets of parameters for resource selection for a MCST. The apparatus may include means for identifying a resource selection window based at least in part on the one or more sets of parameters. The apparatus may include means for selecting a set of candidate multi-slot resources in accordance with the resource selection window and based at least in part on a threshold associated with the MCST. The apparatus may include means for performing a transmission associated with at least one of the set of candidate multi-slot resources.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of resource selection for a single-slot sidelink transmission, in accordance with the present disclosure.

FIG. 7 is a diagram illustrating an example of candidate resource identification based at least in part on sensing, in accordance with various aspects of the present disclosure.

FIG. 8 is a diagram illustrating an example of resource selection for sidelink communications, in accordance with the present disclosure.

FIG. 9 is a diagram illustrating examples of resource selection for multiple consecutive slot transmission (MCST), in accordance with the present disclosure.

FIG. 10 is a diagram illustrating an example of determining a proportion of available multi-slot resources, in accordance with the present disclosure.

FIGS. 11 and 12 are diagrams illustrating examples of resource selection for MCST, in accordance with the present disclosure.

FIG. 13 is a diagram illustrating an example of determining a proportion of available multi-slot resources, in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

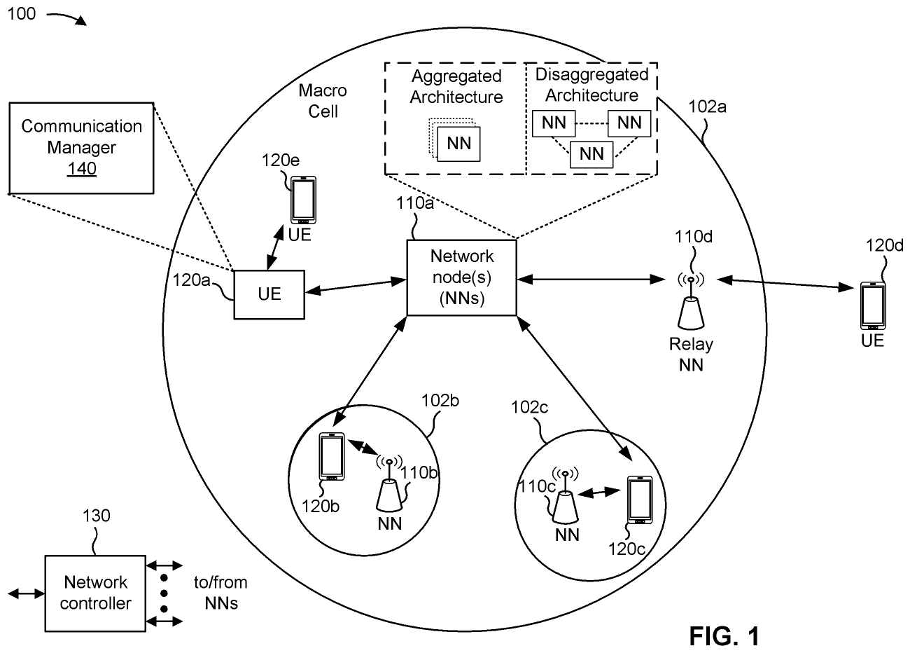

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may identify one or more sets of parameters for resource selection for a multiple consecutive slot transmission (MCST); identify a resource selection window based at least in part on the one or more sets of parameters; select a set of candidate multi-slot resources in accordance with the resource selection window and based at least in part on a threshold associated with the MCST; and perform a transmission associated with at least one of the set of candidate multi-slot resources. Additionally, or alternatively, the communication manager 140 may perform one or more other operations described herein.

As indicated above, FIG. 1 is provided as an example. Other examples may differ from what is described with regard to FIG. 1.

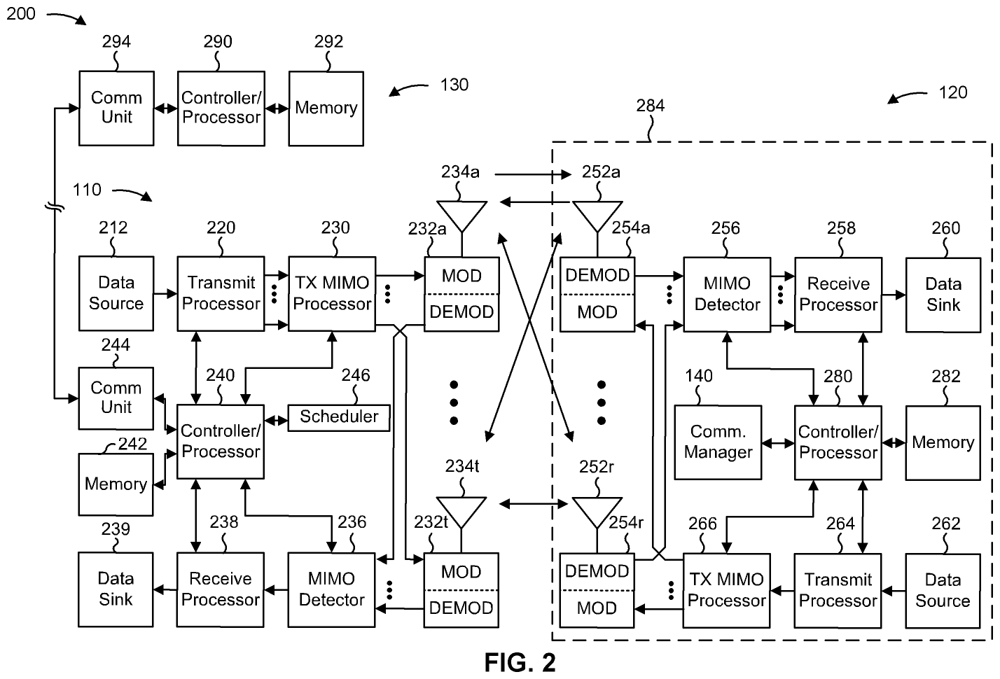

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

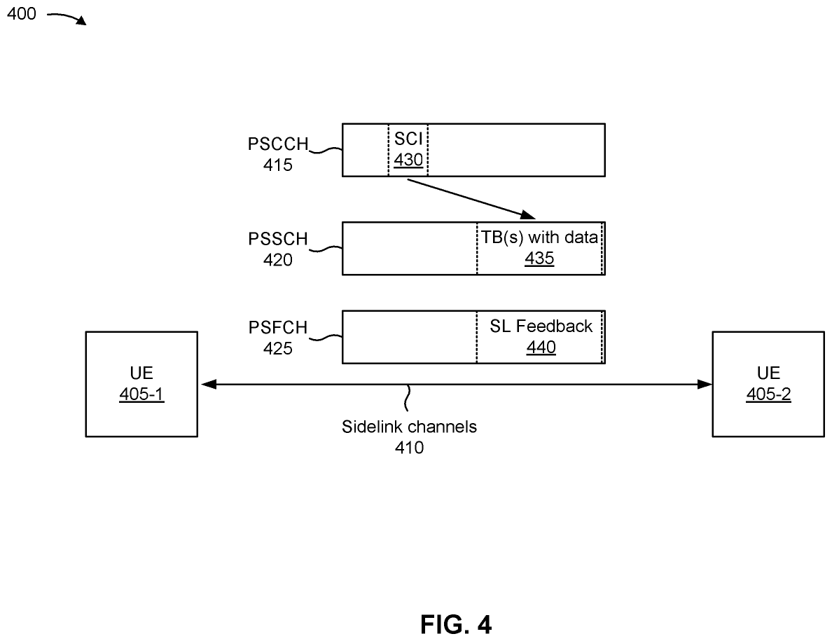

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

The controller/processor 240 of the network node 110, the controller/processor 280 of the UE 120, or any other component(s) of FIG. 2 may perform one or more techniques associated with MCST on the sidelink, as described in more detail elsewhere herein. For example, the controller/processor 240 of the network node 110, the controller/processor 280 of the UE 120, or any other component(s) (or combinations of components) of FIG. 2 may perform or direct operations of, for example, process 1400 of FIG. 1400, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1400 of FIG. 1400, and/or other processes as described herein. In some examples, executing instructions may include running the instructions, converting the instructions, compiling the instructions, and/or interpreting the instructions, among other examples.

In some aspects, a UE includes means for identifying one or more sets of parameters for resource selection for an MCST; means for identifying a resource selection window based at least in part on the one or more sets of parameters; means for selecting a set of candidate multi-slot resources in accordance with the resource selection window and based at least in part on a threshold associated with the MCST; and/or means for performing a transmission associated with at least one of the set of candidate multi-slot resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

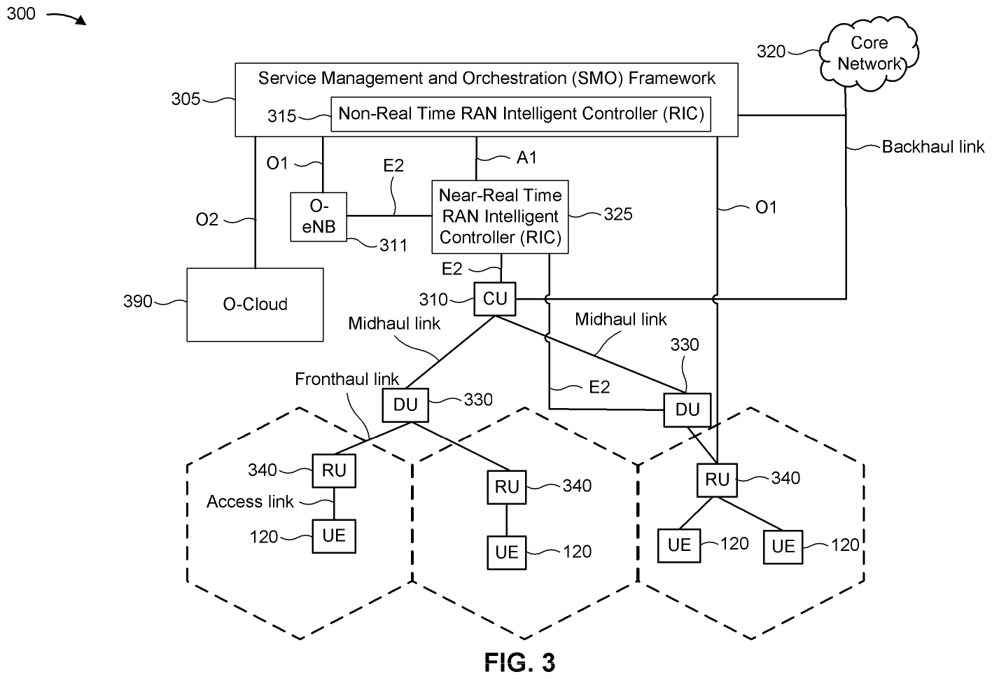

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

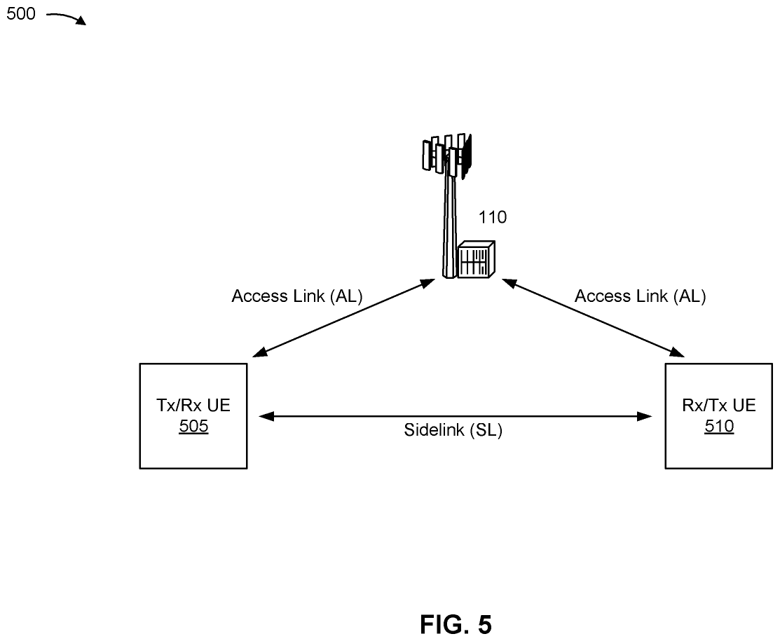

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

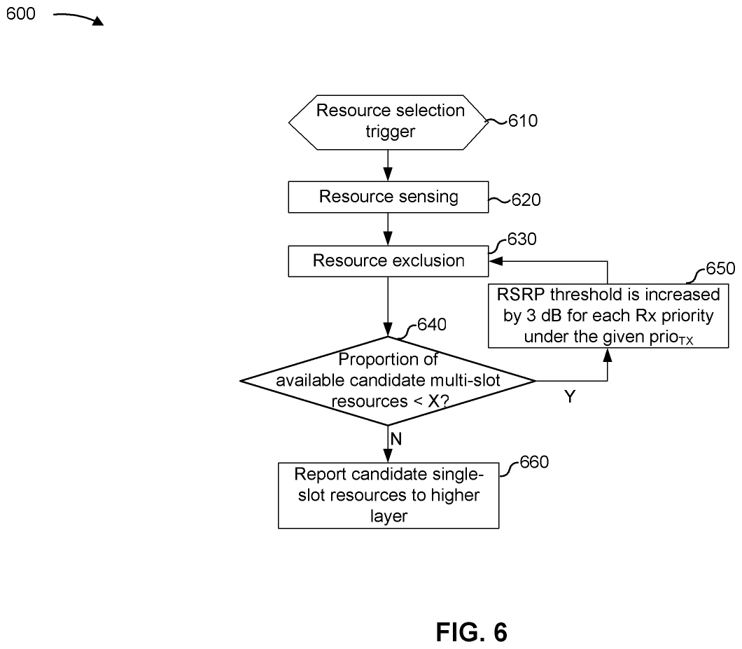

FIG. 6 is a diagram illustrating an example 600 of resource selection for a single-slot sidelink transmission, in accordance with the present disclosure. The operations of example 600 may be performed by a UE (e.g., UE 120, UE 405, UE 505, UE 510).

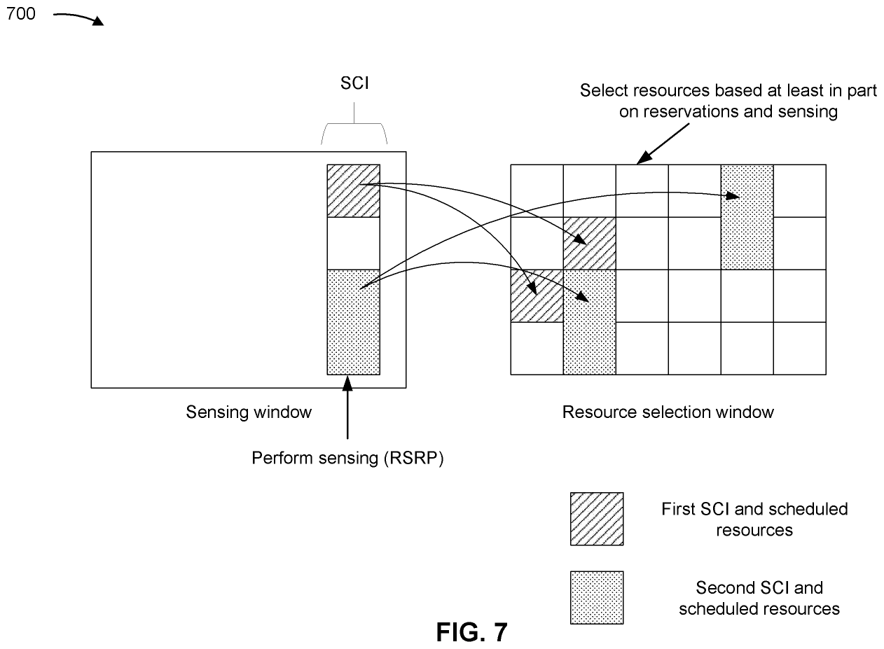

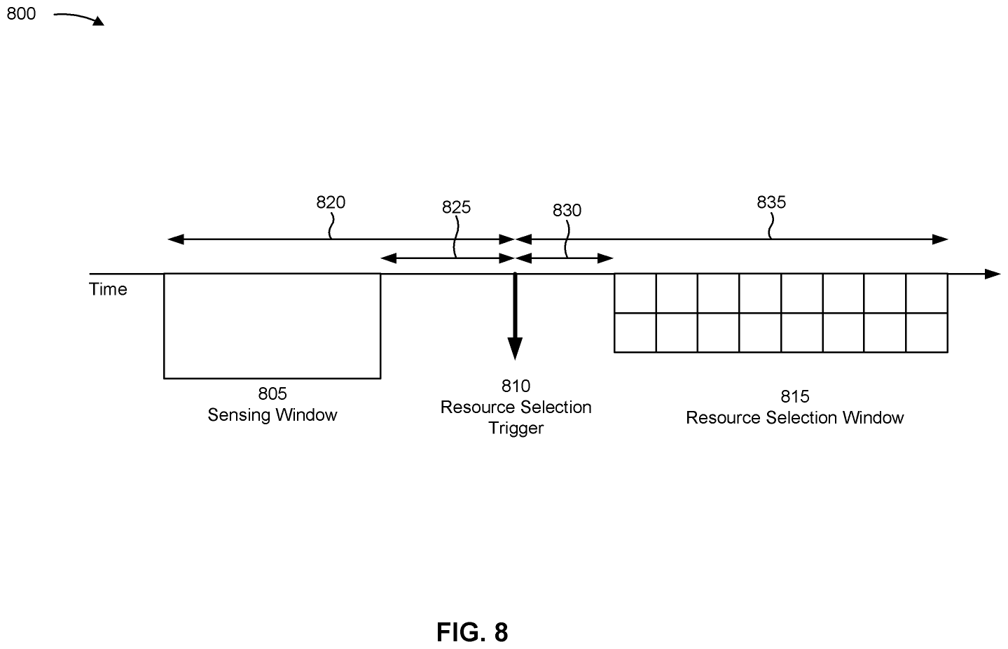

As shown by reference number 610, the UE may identify a resource selection trigger, as described in more detail in connection with FIGS. 7-8. As shown by reference number 620, the UE may perform resource sensing, as described in more detail in connection with FIGS. 7-8. As shown by reference number 630, the UE may perform resource exclusion, as described in more detail in connection with FIGS. 7-8. Resource sensing and resource exclusion may be collectively referred to as identification of candidate resources. After candidate resources are identified, and once a proportion of available candidate resources satisfies a threshold associated with single-slot transmission (as described below), the available candidate resources that satisfy the threshold may be reported to a higher layer of the UE as selected candidate resources (as described below).

As shown by reference number 640, the UE may determine whether a proportion of available candidate single-slot resources (e.g., as determined by the sensing) fails to satisfy a threshold associated with single slot transmission (e.g., X) (sometimes referred to herein as another threshold). As shown by reference number 650, if the proportion fails to satisfy the threshold, the UE may increase an RSRP threshold (for example, by 3 dB) for each reception priority associated with a transmission priority (e.g., prio_{TX}) of the set of parameters for single-slot transmission, and may return to reference number 630 (e.g., may perform resource exclusion using the increased threshold). As shown by reference number 660, if the proportion satisfies the threshold, the UE may report candidate single-slot resources to a higher layer (e.g., a MAC layer) of the UE, such as for resource selection or reservation for a single-slot transmission (e.g., a sidelink transmission) of the UE. The higher layer may select resources for a transmission, for example, by random selection.

As indicated above, FIG. 6 is provided as an example. Other examples may differ from what is described with regard to FIG. 6.

FIG. 7 is a diagram illustrating an example 700 of candidate resource identification based at least in part on sensing, in accordance with various aspects of the present disclosure. Example 700 relates to a mode where UEs of a sidelink network autonomously determine resource allocations. Example 700 includes a sensing window and a resource selection window. In the sensing window, a UE may decode SCI, such as to determine whether a resource in the resource selection window is available or not. SCI may indicate a resource reservation, and may indicate a priority level associated with the resource reservation. In example 700, the resources reserved by each SCI are indicated by a matching fill and an arrow from the SCI to the reserved resource.

The UE may perform sensing with regard to the SCI in the sensing window, as mentioned above in connection with reference number 620. For example, the UE may determine a measurement such as an RSRP measurement with regard to the SCI. The UE may select resources in the resource selection window based at least in part on the RSRP. Thus, the RSRP of the transmission associated with the SCI may be said to be projected onto the resource selection window. The UE may measure the RSRP on a PSCCH, a PSSCH (e.g., a DMRS of the PSSCH), or the like, according to a configuration (e.g., an RRC configuration, a preconfiguration, or the like). The sensing window may have a length, which may be configured (e.g., RRC configuration, preconfiguration, or the like). The configurations used for determination of the resource selection window and the sensing window may be collectively referred to as a set of parameters, and are described in more detail elsewhere herein.

The UE may select resources based at least in part on the RSRP and/or the priorities, which is referred to above as resource exclusion (where excluded resources are not selected). For example, the UE may determine whether a resource in the resource selection window is associated with SCI in the sensing window for which an RSRP satisfies a threshold (e.g., a threshold for single-slot transmission, as described above). If the RSRP satisfies the threshold (e.g., if the RSRP is sufficiently strong), the UE may determine that the reserved resource is unavailable. If the RSRP fails to satisfy the threshold, the resource is considered available. In some aspects, the UE may determine resource availability based at least in part on a priority level. For example, the UE may disregard reservations associated with lower priority levels than a communication to be performed by the UE, or the UE may modify one or more thresholds associated with resource selection based at least in part on the priority levels. In some aspects, the threshold for the RSRP may be configured per transmitter priority (e.g., prio_{TX}) and receiver priority (e.g., prio_{RX}) pair, meaning that a threshold is specific to a priority level associated with a transmitter of a communication and a receiver of the communication. In some aspects, the UE may adjust the threshold for the RSRP, as mentioned above with regard to reference number 650. For example, if the proportion of available resources in the resource selection window is less than a threshold (e.g., 20%), then the RSRP threshold may be increased, and the process may be repeated.

Available resources in the resource selection window may form a candidate resource set. The UE may report the candidate resource set to a higher layer of the UE (e.g., higher than the PHY layer), as mentioned above with regard to reference number 660. Resources for a transmission (e.g., a packet) may be selected such that all retransmissions for the transmission occur within a delay budget (e.g., a packet delay budget) associated with the packet.

The UE (e.g., a layer of the UE) may receive or determine a resource selection trigger, as mentioned above with regard to reference number 610. A resource selection trigger indicates that the UE is to perform a transmission, so resources are to be selected. The UE may look backward in time, upon receiving the resource selection trigger, to the sensing window based at least in part on a configured or preconfigured time window. The UE may select future resources in the resource selection window based at least in part on the sensing window, as described in more detail with regard to FIG. 8.

As indicated above, FIG. 7 is provided as an example. Other examples may differ from what is described with regard to FIG. 7.

FIG. 8 is a diagram illustrating an example 800 of resource selection for sidelink communications, in accordance with the present disclosure. As shown in FIG. 8, a UE 120 may use a channel sensing procedure to select resources for sidelink communication in a Mode 2, such as described above in connection with FIG. 4.

As shown in FIG. 8, a UE 120 may perform a channel sensing procedure in a sensing window 805 (e.g., using antenna 252, DEMOD 254, MIMO detector 256, receive processor 258, controller/processor 280, or memory 282). In some cases, the sensing window 805 may be 100 milliseconds (e.g., for aperiodic resource reservation, such as aperiodic reservation in one or more slots of up to 32 logical slots in the future) or 1100 milliseconds (e.g., for periodic resource reservation). In some cases, a UE 120 configured for communication in an NR network may use a sensing procedure for aperiodic or periodic resource reservation.

According to the channel sensing procedure, the UE 120 may decode control messages relating to resource reservations of other UEs 120, as well as perform measurements (e.g., RSRP measurements and/or RSSI measurements, among other examples) associated with one or more sidelink channels (e.g., using antenna 252, DEMOD 254, MIMO detector 256, receive processor 258, controller/processor 280, and/or memory 282). This is referred to above as resource sensing, such as at reference number 620 of FIG. 6. The other UEs 120 may transmit reservation information (e.g., in SCI) that indicates a resource reservation for a current slot (e.g., the slot in which the reservation information is transmitted) and for one or more (e.g., up to two) future slots. The UE 120 may monitor for and decode the reservation information during the sensing window 805 to determine a channel availability (e.g., to determine available resources) of the sidelink channel. The channel sensing may be performed by a PHY layer of the UE 120. The PHY layer may select or identify the available candidate resources in a resource selection window as described in more detail below and may generate a report of the channel sensing (e.g., of resources that are occupied or reserved based at least in part on the measurements and/or sensing performed at the PHY layer). The PHY layer may provide the report to a MAC layer of the UE 120. The MAC layer may select candidate resources for resource reservation or transmission, based at least in part on the report from the PHY layer.

As shown in FIG. 8, the UE 120 (e.g., the physical layer of the UE 120) may determine to select resources for a sidelink communication based at least in part on a resource selection trigger 810 (e.g., using controller/processor 280 and/or memory 282), referred to above by reference number 610. For example, resource selection may be triggered when the UE 120 has a packet that is to be transmitted or when the UE 120 receives an indication to select (or reselect) resources for a packet that is to be transmitted by the UE 120. Based at least in part on the resource selection trigger 810, the UE 120 may determine one or more resources that are available for selection in a resource selection window 815 (referred to as candidate resources). That is, the UE 120 may determine the one or more available resources based at least in part on the channel sensing procedure performed by the UE 120. For example, the channel sensing procedure may provide an indication of resources in the resource selection window 815 that are occupied and/or resources in the resource selection window 815 associated with high interference.

The sensing window 805 may be based at least in part on a timing associated with the resource selection trigger 810. For example, as shown by reference number 820, the sensing window may begin at a time T₀ from the resource selection trigger 810.

As shown by reference number 825, the sensing window 805 may end at a time T_{proc,0} from the resource selection trigger 810. T_{proc,0} may be based at least in part on a processing time associated with the UE 120. In other words, the UE 120 may continually perform channel sensing associated with the sidelink channel described above. When the UE 120 is triggered to select resources for a sidelink communication, the UE 120 may consider reservation information and/or measurements associated with the channel sensing procedure that were received and/or performed during the sensing window 805.

As shown by reference numbers 830 and 835, if a resource selection trigger 810 occurs at a time n, the resource selection window 815 may be from n+T₁ to n+T₂. In some aspects, T₁ may be less than a processing time (T_{proc,1}) associated with the UE 120. In some aspects, a timing difference (T₂) may be greater than or equal to a minimum timing difference (T_{2,min}), which may be a value configured for the UE based at least in part on a priority of the UE 120, and less than or equal to a remaining packet delay budget (PDB) of the packet to be transmitted by the UE 120. A PDB is a constraint indicating a maximum allowable delay between a time of packet arrival (e.g., at a UE) and a time of a last transmission of the packet. In some aspects, a maximum value of T₂ (e.g., a maximum timing difference) between an ending time of the resource selection window and a resource selection trigger time may be based at least in part on the remaining PDB. T_{2,min} may be configured per priority, and may be a function of a subcarrier spacing of the UE.

As indicated above, FIG. 8 is provided as an example. Other examples may differ from what is described with respect to FIG. 8.

A UE may support MCST on the sidelink, such as MCST in unlicensed sidelink. For example, one or more sets of parameters may be provided for Layer 1 (L1) resource selection (such as by a higher layer of the UE). A set of parameters may include, for example, a transmission priority (prio_{TX}), a remaining PDB, a number of subchannels per resource (e.g., L_{subCH}), a reservation periodicity (P_{rsvp_TX}), a combination thereof, or the like. The PHY layer of the UE may select resources for an MCST on the sidelink. In some examples, a single set of parameters may be provided for resource selection (referred to as Option 1), which may be applicable for transmission of a single transport block and multiple transport blocks. In some examples, one or multiple sets of parameters can be provided for resource selection (referred to as Option 2). The one or more sets of parameters may be provided by a higher layer of the UE to the PHY layer of the UE.

In some examples, when the PHY layer reports a subset of candidate resources for an MCST, the PHY layer may identify and report candidate multi-slot resources, where a candidate multi-slot resource includes a set of two or more single-slot resources that are consecutive in time, referred to as Option A. In some examples, when the PHY layer reports a subset of candidate resources for an MCST, the PHY layer may report candidate single-slot resources (referred to as Option B), as described with regard to reference number 660, above. In at least Option B, the higher layer of the UE may select a set of single-slot resources that are consecutive in slots (e.g., logical slots). In some examples, when the PHY layer reports a subset of candidate resources for an MCST, the PHY layer may report candidate single-slot resources that are consecutive in time, referred to as Option C.

For Option B, the UE can report available single-slot candidate resources for an MCST as described with regard to FIG. 6. However, there may be situations where the number of multi-slot resources that can be derived from the available single-slot candidate resources is less than a number of multi-slot resources that can support the MCST. For Option A, ambiguity may arise in how a set of parameters, or multiple sets of parameters, impact selection of candidate multi-slot resources. For example, different values of a parameter, across multiple sets of parameters, may have different implications for resource selection. A value of prio_{TX} may impact the RSRP threshold (e.g., for RSRP comparison) and the resource selection window (since T_{2,min} is per priority). The remaining PDB may impact the resource selection window. L_{subCH} may impact the frequency granularity of candidate resources. P_{rsvp_TX} may impact the excluded resources. For Option 1 (in which a single set of parameters may be provided for resource selection), difficulties may arise in ensuring that the proportion of available multi-slot resources is sufficient to support consistent MCST. For Option 2, different sets of parameters may correspond to different resource exclusion outcomes, different resource selection windows, and so on. These differences may lead to ambiguities in, for example, how to determine the resource selection window and how to handle a situation in which the proportion of available candidate multi-slot resources is insufficient to support consistent MCST.

Some techniques described herein provide resource selection for an MCST based at least in part on a threshold associated with the MCST. For example, a UE may identify one or more sets of parameters for resource selection for an MCST. The UE may identify a resource selection window based at least in part on the one or more sets of parameters. The UE may select a set of candidate multi-slot resources in accordance with the resource selection window and based at least in part on a threshold associated with the MCST. The UE may perform a transmission associated with at least one of the set of candidate multi-slot resources (such as a resource reservation or an MCST). In this way, the UE may ensure that the proportion of available multi-slot resources is sufficient to support consistent MCST (by using the threshold associated with MCST) and ambiguities regarding Option 2 are resolved.

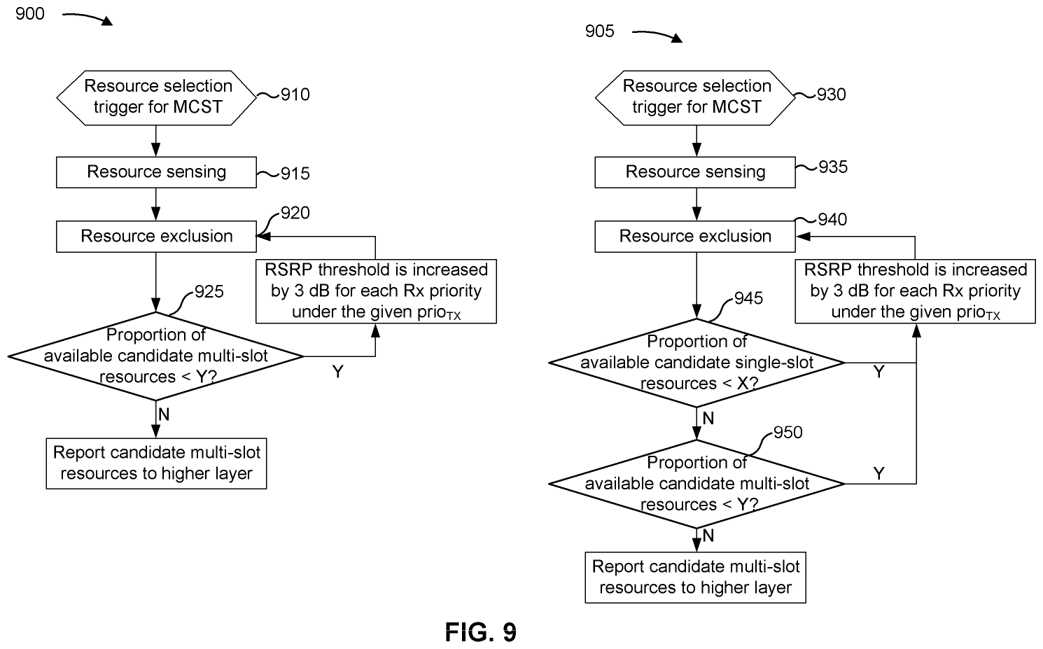

FIG. 9 is a diagram illustrating examples 900 and 905 of resource selection for MCST, in accordance with the present disclosure. The operations of FIG. 9 may be performed by a UE (e.g., UE 120, UE 405, UE 505, UE 510). The operations of FIG. 9 may be performed in the context of Option 1, in which the UE is configured with a single set of parameters and a number of consecutive slots to include in a multi-slot resource for an MCST. The single set of parameters may include, for example, prio_{TX}, remaining PDB, L_{subCH} and P_{rsvp_TX}. In examples 900 and 905, the UE reports candidate multi-slot resources to a higher layer of the UE (e.g., for selection for transmission of an MCST) if a proportion of available multi-slot resources is no less than a threshold (Y) associated with the MCST. In some aspects, the threshold may be configured via RRC signaling. For example, the threshold may be configured via an RRC parameter indicating a threshold for a single-slot transmission (e.g., sl-TxPercentageList). As another example, the threshold may be configured via a different parameter.

In example 900, the UE may identify a resource selection trigger for MCST at reference number 910. In some aspects, the resource selection trigger may be associated with (e.g., may be received with) the single set of parameters. As shown by reference number 915, the UE may perform resource sensing, as described in connection with reference number 620. As shown by reference number 920, the UE may perform resource exclusion according to an RSRP threshold (sometimes referred to as an RSRP threshold list), as described in connection with reference number 630 and FIGS. 7-8. An RSRP threshold can include multiple thresholds (e.g., a threshold list), which may correspond to different reception priorities under a given transmission priority (prio_{TX}).

The UE may determine whether a proportion of available candidate multi-slot resources fails to satisfy the threshold associated with MCST (Y) (reference number 925). In example 900, if a proportion of available candidate multi-slot resources fails to satisfy the threshold associated with MCST (Y) (reference number 925-Y), the UE may increase the RSRP threshold (e.g., by 3 dB) for each reception priority associated with (e.g., under) the transmission priority prio_{TX} indicated by the set of parameters, and may return to reference number 920. Thus, the UE may directly check if the proportion of available candidate multi-slot resources is no less than Y after resource exclusion, where Y is a ratio. If the proportion of available candidate multi-slot resources is less than Y (as described above), the RSRP threshold is increased for each reception priority under the given prior, and the candidate resource identification process is repeated. Once the proportion of available candidate multi-slot resources is satisfied (e.g., equal to or larger than Y), the UE may report available candidate multi-slot resources to a higher layer.

Example 905 may be referred to as a two-step approach. The two-step approach is referred to as a two-step approach because the UE determines whether a proportion of available candidate single-slot resources satisfies a first threshold and whether a proportion of available candidate multi-slot resources (selected from the available candidate single-slot resources) satisfies a second threshold.

In example 905, the UE may identify a resource selection trigger for MCST at reference number 930. In some aspects, the resource selection trigger may be associated with (e.g., may be received with) the single set of parameters. As shown by reference number 935, the UE may perform resource sensing, as described in connection with reference number 620. As shown by reference number 940, the UE may perform resource exclusion according to an RSRP threshold (sometimes referred to as an RSRP threshold list), as described in connection with reference number 630 and FIGS. 7-8. An RSRP threshold can include multiple thresholds (e.g., a threshold list), which may correspond to different reception priorities under a given transmission priority (prio_{TX}).

At reference number 945, the UE may determine whether a proportion of available single-slot resources in the resource selection window fails to satisfy a threshold (sometimes referred to as another threshold) associated with a single slot transmission (X). If the proportion fails to satisfy X, (reference number 945-Y), the UE may increase the RSRP threshold (e.g., by 3 dB) for each reception priority associated with (e.g., under) the transmission priority prio_{TX} indicated by the set of parameters, and may return to reference number 940.

At reference number 950, if the proportion of available single-slot resources in the resource selection window satisfies X, the UE may determine whether a proportion of candidate multi-slot resources (selected from the available single-slot resources) fails to satisfy a threshold associated with MCST (Y). If the proportion fails to satisfy Y, (reference number 950-Y), the UE may increase the RSRP threshold (e.g., by 3 dB) for each reception priority associated with (e.g., under) the transmission priority prio_{TX} indicated by the set of parameters, and may return to reference number 940. Thus, if the proportion of available candidate single-slot resources is less than X, the RSRP threshold may be increased for each reception priority under the given prio_{TX} and the candidate resource identification process is repeated (where X is the percentage or ratio configured for single-slot resources). If the proportion of available multi-slot resources after is less than Y, the RSRP threshold may be increased for each reception priority under the given prio_{TX} and the candidate resource identification process is repeated.

As indicated above, FIG. 9 is provided as an example. Other examples may differ from what is described with regard to FIG. 9.

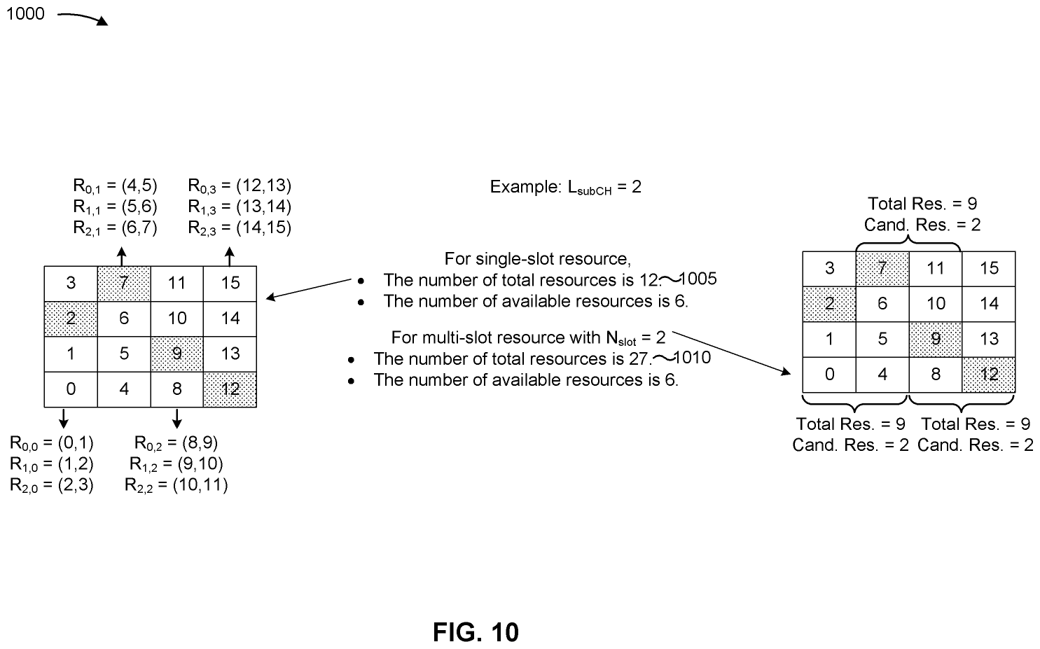

FIG. 10 is a diagram illustrating an example 1000 of determining a proportion of available multi-slot resources, in accordance with the present disclosure. A candidate multi-slot resource for transmission may be defined as a set of Nₛₗₒₜ contiguous single-slot resources in time, where a single-slot resource R_{xy} is defined as a set of L_{subCH} contiguous sub-channels with sub-channel x+j in slot

$${t}_{y}^{′ SL}$$

where j=0, 1, . . . , L_{subCH}−1, and where

$${t}_{y}^{′ SL}$$

denotes a slot which belongs to the sidelink resource pool. The proportion of available multi-slot resources are calculated by the number of available multi-slot resources divide by the number of total multi-slot resources. In FIG. 10, an available sub-channel and slot (sub-channel/slot) combination is indicated by a white fill and an unavailable sub-channel and slot resource is indicated by a dotted fill. In FIG. 10, L_{subCH} is 2. In FIG. 10, Nₛₗₒₜ is 2. In FIG. 10, the horizontal axis represents time (e.g., slots, logical slots) and the vertical axis represents frequency (e.g., sub-channels).

As shown by reference number 1005, there are 12 total single-slot resources in a resource grid. Of these 12 total single-slot resources, 6 single-slot resources contain one of the unavailable sub-channels and slots (indexed as 2, 7, 9, and 12). Therefore, 6 single-slot resources (that do not contain any unavailable sub-channel/slot combinations) can be considered available: R_{0,1}, R_{1,1}, R_{1,3}, R_{2,3}, R_{0,0}, and R_{2,2}. The UE may determine the proportion of available single-slot resources as (available single-slot resources/total single-slot resources)=6/12=0.5.

As shown by reference number 1010, there are 27 total multi-slot resources. For example, a multi-slot resource may be composed of L_{subCH} contiguous sub-channels in a first slot and L_{subCH} contiguous sub-channels (which may or may not occupy the same frequency resources as the sub-channels in the first slot) in a second slot that is contiguous in time with the first slot. Therefore, for example, [2, 3; 6, 7], [2, 3; 5, 6], and [2, 3; 4, 5] are all valid multi-slot resources, and may or may not considered available depending on availability of the underlying single-slot resources (and by extension the underlying subchannel/slot combinations). Furthermore, of the 27 total multi-slot resources, 6 multi-slot resources may be considered as available since these 6 multi-slot resources do not contain any unavailable sub-channel/slot combinations: [0, 1; 4, 5], [0, 1; 5, 6], [4, 5; 10, 11], [5, 6; 10, 11], [10, 11; 13, 14], and [10, 11; 14, 15]. The UE may determine the proportion of available multi-slot resources as (available multi-slot resources/total multi-slot resources)=6/27=0.22.

As indicated above, FIG. 10 is provided as an example. Other examples may differ from what is described with regard to FIG. 10.

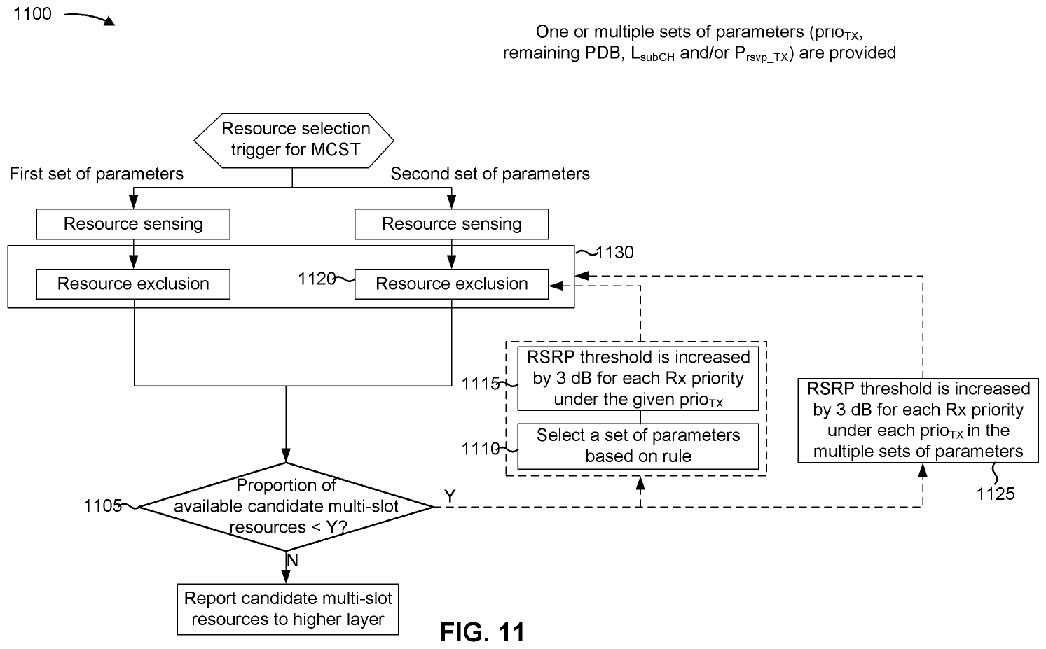

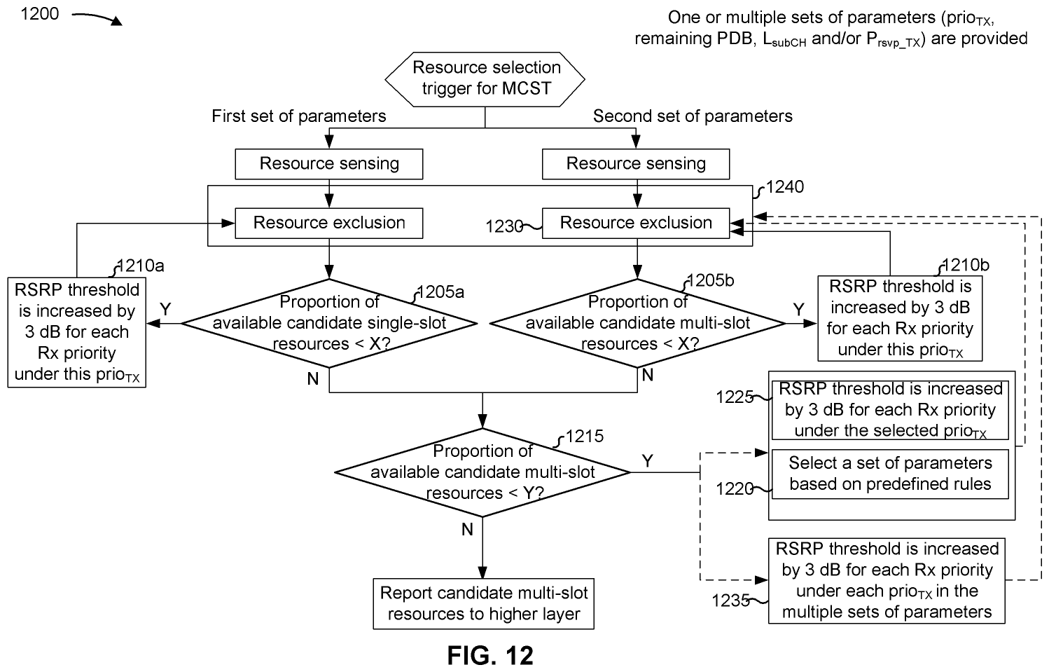

FIGS. 11 and 12 are diagrams illustrating examples 1100 and 1200 of resource selection for MCST, in accordance with the present disclosure. The operations of examples 1100 and/or 1200 may be performed by a UE (e.g., UE 120, UE 405, UE 505, UE 510). In examples 1100 and 1200, one or more sets of parameters (e.g., prio_{TX}, remaining PDB, L_{subCH} and P_{rsvp_TX}) are identified by the UE. For example, the UE may identify a first set of parameters and a second set of parameters.

The UE may identify a resource selection window based at least in part on the one or more sets of parameters. For example, the UE may determine one or more parameters of the resource selection window (e.g., one or more of the parameters indicated by reference numbers 820, 825, 830, and/or 835 in FIG. 8) using the one or more sets of parameters. In some aspects, the UE may determine the resource selection window separately for each set of parameters of the one or more sets of parameters. For example, the UE may determine a first resource selection window for the first set of parameters and a second resource selection window for the second set of parameters.

In some aspects, the UE may determine a single resource selection window for multiple sets of parameters. For example, the UE may determine the resource selection window jointly for multiple sets of parameters, such that a single resource selection window is determined for multiple sets of parameters. For example, the UE may determine a maximum timing difference between an end of the resource selection window and a resource trigger time, (which is based on a remaining PDB) based at least in part on a smallest remaining PDB among the multiple sets of parameters. As another example, the UE may determine a minimum timing difference between an end of the resource selection window and a resource trigger time (which is based at least in part on T_{2,min}) based at least in part on a T_{2,min} associated with a prio_{TX} parameter of a set of parameters including the smallest remaining PDB. As another example, the UE may determine the minimum timing difference (which is based at least in part on T_{2,min}) based at least in part on a T_{2,min} associated with a prio_{TX} parameter of a set of parameters including the highest transmission priority value (or, in other examples, the lowest transmission priority value). As another example, the UE may determine the minimum timing difference (which is based at least in part on T_{2,min}) based at least in part on a largest T_{2,min} of the multiple sets of parameters.

In some aspects, the UE may receive configuration information indicating whether the UE should determine the resource selection window jointly or separately for the multiple sets of parameters. In some aspects, whether the UE determines the resource selection window jointly or separately for the multiple sets of parameters may be based at least in part on a UE capability of the UE. For example, the UE may determine the resource selection window separately for each set of parameters if the UE does not support joint resource selection window determination, or the UE may determine the resource selection window jointly for the multiple sets of parameters if the UE supports joint resource selection window determination (e.g., based at least in part on the configuration information described above). The UE may transmit, and another UE may receive, the capability information.

The UE may perform candidate resource exclusion (e.g., as described with regard to reference number 630 of FIG. 6) for each single-slot resource corresponding to a set of parameters in the determined resource selection window. The UE may report candidate multi-slot resources to a higher layer if the proportion of available multi-slot resources is no less than a threshold (e.g., Y) where the threshold Y can be configured by RRC, as described in more detail below. The threshold can be common for different priorities or can be per-priority.

In the identification of the resource selection window, the selection of T₁ may be up to UE implementation under 0≤T₁≤T_{proc,1}, where T_{proc,1} depends on the subcarrier spacing of the UE (as mentioned above). So for multiple sets of parameters, T₁ may be expected to have the same range. However, a range of T₂ (which corresponds to the timing difference between an end of the resource selection window and a resource trigger time as described above) may be based at least in part on the set of parameters, where T_{2,min}≤T₂≤(remaining PDB) if T_{2,min} is less than the remaining PDB and otherwise, T_{2,min}=remaining PDB.

For example, consider a first set of parameters (prio_{TX1}, remaining PDB1, L_{subCH1}, and P_{rsvp_TX1}) corresponding to a T_{2,min1}=5 ms and a remaining PDB1=20 ms. Consider also a second set of parameters (prio_{TX2}, remaining PDB2, L_{subCH2}, and P_{rsvp_TX2}) corresponding to a T_{2,min2}=10 ms and a remaining PDB2=50 ms. If the UE determines resource selection windows separately for the first set of parameters and the second set of parameters, the UE may determine T₂ as 5≤T₂≤20 for the first set of parameters and 10≤T₂≤50 for the second set of parameters. If the UE determines a resource selection window jointly for the two sets of parameters, the UE may determine T₂ as T_{2,min}≤T₂≤(remaining PDB), where remaining PDB=minimum (remaining PDB1, remaining PDB2)=20 ms. In some aspects, as described above, the UE may determine T_{2,min}=T_{2,min1}=5 ms, such that 5 ms≤T₂≤20 ms. In some aspects, as described above, the UE may determine T_{2,min}=T_{2,min} {maximum (prio_{TX1}, prio_{TX2})}, such that T_{2,min1}=5 ms. Thus, if prio_{TX1}>prio_{TX2}, the UE may determine T₂ as 5 ms≤T₂≤20 ms. In some aspects, the UE may determine T_{2,min}=maximum (T_{2,min1}, T_{2,min2})=10 ms, such that 10 ms≤T₂≤20 ms.

As mentioned above, the UE may perform resource exclusion. For example, the UE may compare a measured RSRP and an RSRP threshold. However, the RSRP threshold may be defined according to a (transmitter priority, receiver priority) pair. Therefore, in situations where the UE is configured with multiple sets of parameters (including at least multiple transmitter priorities), ambiguity may arise regarding whether the UE should use a separate RSRP threshold list for each separate set of parameters, or a single RSRP threshold list jointly for multiple sets of parameters. In some aspects, described herein, the UE may determine a separate RSRP threshold list for each set of parameters of the multiple sets of parameters. In some aspects, the UE may determine a single RSRP threshold list based at least in part on a rule (e.g., a predefined rule), and the UE may apply the single RSRP threshold list for each set of parameters of the multiple sets of parameters. In some aspects, the rule may indicate that an RSRP threshold list with a largest RSRP threshold for each receiver priority is to be selected. In some aspects, the rule may indicate that an RSRP threshold list with a smallest RSRP threshold for each receiver priority is to be selected. In some aspects, the rule may indicate that an RSRP threshold list associated with a largest prio_{TX} value is to be selected. In some aspects, the rule may indicate that an RSRP threshold list associated with a smallest prio_{TX} value is to be selected. In some aspects, the UE may receive configuration information indicating whether the UE should determine the RSRP threshold list jointly or separately for the multiple sets of parameters. In some aspects, whether the UE determines the RSRP threshold list jointly or separately for the multiple sets of parameters may be based at least in part on a UE capability of the UE. For example, the UE may determine the RSRP threshold list separately for each set of parameters if the UE does not support joint RSRP threshold list determination, or the UE may determine the RSRP threshold list jointly for the multiple sets of parameters if the UE supports joint RSRP threshold list determination (e.g., based at least in part on the configuration information described above). The UE may transmit, and another UE may receive, the capability information. In some aspects, the capability information may be the same capability information as for joint or separate resource selection window determination, described above. In some aspects, the configuration information may be the same configuration information as for joint or separate resource selection window determination, described above.

FIGS. 11 and 12 illustrate examples of how a UE can ensure that a proportion of available multi-slot resources, reported to a higher layer of the UE, is no less than a threshold associated with MCST (Y). In FIG. 11, the UE determines whether the proportion of available candidate multi-slot resources fails to satisfy Y after resource exclusion. In FIG. 12, the UE performs a two-step approach, in which the UE first determines whether the proportion of available candidate single-slot resources for one or more sets of parameters in the multiple sets of parameters is less than X, and then determines whether the proportion of available candidate multi-slot resources is less than Y. Each is described in turn below.

In FIG. 11, as shown by reference number 1105, the UE may determine whether a proportion of available candidate multi-slot resources fails to satisfy a threshold associated with MCST (e.g., Y) after performing resource exclusion. For example, the UE may perform resource sensing and exclusion separately (or jointly) for the first set of parameters and the second set of parameters, and may then determine whether the proportion of available candidate multi-slot resources, determined as a result of the sensing and exclusion, fails to satisfy the threshold.

In some aspects, if the proportion fails to satisfy the threshold (reference number 1105-Y), the UE may increase an RSRP threshold and repeat the resource exclusion for each set of parameters sequentially. For example, the UE may select a set of parameters, of the multiple sets of parameters, based at least in part on a rule (reference number 1110). The UE may increase an RSRP threshold (e.g., by 3 dB) for each reception priority associated with a transmission priority of the selected set of parameters (reference number 1115). The UE may perform resource exclusion using the increased RSRP threshold for the selected set of parameters (reference number 1120). In example 1100, the selected set of parameters is the second set of parameters. After repeating the resource exclusion procedure for a first selected set of parameters, if the proportion still fails to satisfy the threshold, the UE may select a different set of parameters based on the rule (reference number 1110), and repeat the above procedure for the second selected set of parameters. In example 1100, the second selected set of parameters may be the first set of parameters. In some aspects, the rule may be based at least in part on an order (e.g., a descending order) of the prio_{TX} values in the multiple sets of parameters, such that a set of parameters with a highest transmission priority value is first selected. If the proportion still fails to satisfy the threshold after increasing an RSRP threshold (e.g., by 3 dB) for each reception priority associated with the highest transmission priority value, the UE may select a second highest transmission priority value and repeat the resource exclusion procedure for the set of parameters corresponding to the second highest transmission priority value. In some aspects, the rule may be based at least in part on an order (e.g., an increasing order) of the L_{subCH} values of the multiple sets of parameters, such that a set of parameters with a lowest sub-channel number value is first selected and a set of parameters with a second lowest sub-channel number value is secondly selected if the proportion does not satisfy Y. In some aspects, the rule may be based at least in part on an order (e.g., an increasing order) of the reservation periodicity values of the multiple sets of parameters.

Alternatively, if the proportion fails to satisfy the threshold (reference number 1105-Y), the UE may increase respective RSRP thresholds for each reception priority associated with each transmission priority of the multiple sets of parameters (reference number 1125). The UE may perform resource exclusion separately for each set of parameters using the increased RSRP thresholds (reference number 1130). Thus, the UE may increase the RSRP threshold for each Rx priority under each prio_{TX} value in the multiple sets of parameters and may repeat the candidate resource exclusion for each of the multiple sets of parameters.

In FIG. 12, as shown by reference numbers 1205a and 1205b, the UE may determine, for each set of parameters, whether a proportion of available candidate single-slot resources fails to satisfy a threshold (sometimes referred to as another threshold) associated with single-slot transmission (e.g., X) after performing resource exclusion. If a proportion of available candidate single-slot resources fails to satisfy the threshold (reference number 1205-Y), then the UE may increase an RSRP threshold (e.g., by 3 dB) for each reception priority associated with (e.g., under) a transmission priority of the corresponding set of resources (reference numbers 1210a and 1210b), and may perform resource exclusion using the increased RSRP threshold.

If the proportion of available candidate single-slot resources satisfies the threshold for each set of parameters (reference number 1205-N), then the UE may determine whether a proportion of available candidate multi-slot resources (e.g., selected from the available candidate single-slot resources) satisfies a threshold associated with MCST (Y) (reference number 1215).

In some aspects, if the proportion fails to satisfy the threshold (reference number 1215-Y), the UE may increase an RSRP threshold and repeat the resource exclusion for each set of parameters sequentially. For example, the UE may select a set of parameters, of the multiple sets of parameters, based at least in part on a rule (reference number 1220). The UE may increase an RSRP threshold (e.g., by 3 dB) for each reception priority associated with a transmission priority of the selected set of parameters (reference number 1225). The UE may perform resource exclusion using the increased RSRP threshold for the selected set of parameters (reference number 1230). In example 1200, the selected set of parameters is the second set of parameters. After repeating the resource exclusion procedure for a first selected set of parameters, if the proportion still fails to satisfy the threshold, the UE may select a different set of parameters based on the rule (reference number 1220), and repeat the above procedure for the second selected set of parameters. In example 1200, the second selected set of parameters may be the first set of parameters. In some aspects, the rule may be based at least in part on an order (e.g., a descending order) of the prio_{TX} values in the multiple sets of parameters, such that a set of parameters with a highest transmission priority value is selected. If the proportion still fails to satisfy the threshold after increasing an RSRP threshold (e.g., by 3 dB) for each reception priority associated with the highest transmission priority value, the UE may select a second highest transmission priority value and repeat the resource exclusion procedure for the set of parameters corresponding to the second highest transmission priority value. In some aspects, the rule may be based at least in part on an order (e.g., an increasing order) of the L_{subCH} values of the multiple sets of parameters, such that a set of parameters with a lowest sub-channel number value is first selected and a set of parameters with a second lowest sub-channel number value is secondly selected if the proportion does not satisfy Y. In some aspects, the rule may be based at least in part on an order (e.g., an increasing order) of the reservation periodicity values of the multiple sets of parameters.

Alternatively, if the proportion fails to satisfy the threshold (reference number 1215-Y), the UE may increase respective RSRP thresholds (e.g., by 3 dB) for each reception priority associated with each transmission priority of the multiple sets of parameters (reference number 1235). The UE may perform resource exclusion separately for each set of parameters using the increased RSRP thresholds (reference number 1240). Thus, the UE may increase the RSRP threshold for each reception priority under each prio_{TX} value in the multiple sets of parameters and may repeat the candidate resource exclusion for each of the multiple sets of parameters.

As indicated above, FIGS. 11 and 12 are provided as examples. Other examples may differ from what is described with regard to FIGS. 11 and 12.

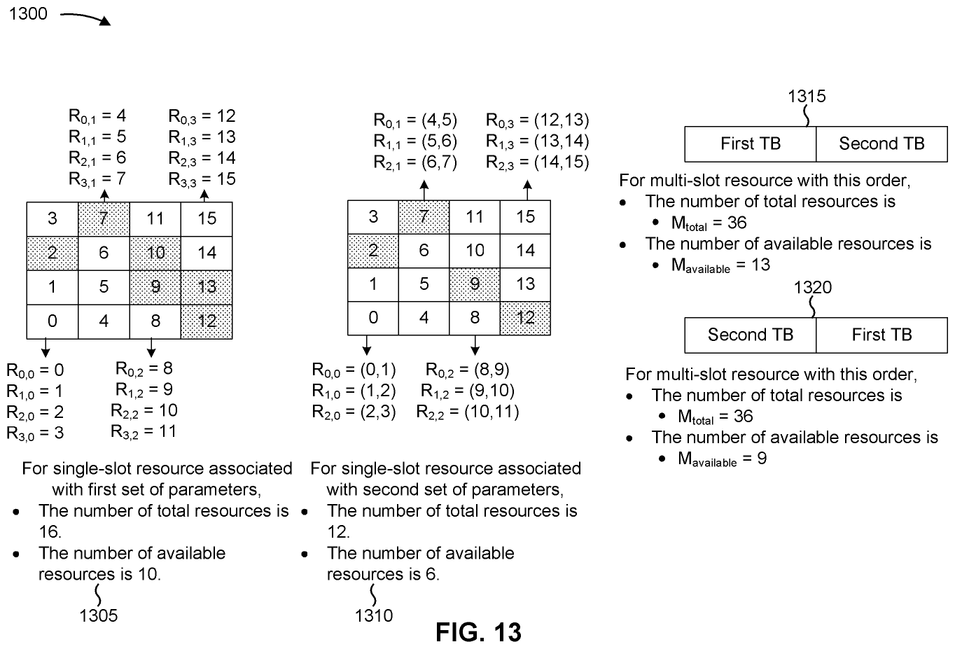

FIG. 13 is a diagram illustrating an example 1300 of determining a proportion of available multi-slot resources, in accordance with the present disclosure. The operations of example 1300 may be performed by a UE (e.g., UE 120, UE 405, UE 505, UE 510). The determination of the proportion of available multi-slot resources can be applied, for example, for determination of the proportion of the available multi-slot resources as described in any process herein (e.g., as described in connection with FIGS. 11 and/or 12).

In some aspects, the UE may determine a proportion of available multi-slot resources. As mentioned above, a candidate multi-slot resource for transmission may be defined as a set of Nₛₗₒₜ contiguous single-slot resources in time, where a single-slot resources R_{xy} is defined as a set of L_{subCH} contiguous sub-channels with sub-channel x+j in slot

$${t}_{y}^{′ SL}$$

where j=0, 1, . . . , L_{subCH}−1,

$${t}_{y}^{′ SL}$$

denotes a slot which belongs to the sidelink resource pool. The proportion of available multi-slot resources may be determined by dividing the number of available multi-slot resources in an order, by the number of total multi-slot resources in the order. In some aspects, the particular order can be fixed or can be provided by a higher layer of the UE. In some aspects, the UE may determine the proportion for any combination (e.g., all combinations) of the multiple sets of parameters, and may select a combination, from the combinations, with a largest proportion of available multi-slot resources.

In example 1300, the first set of parameters has an L_{subCH} value of 1 and the second set of parameters has an L_{subCH} value of 2. As shown by reference number 1305, for single-slot resources identified using the first set of parameters, the number of total single-slot resources is 16 and the number of available single-slot resources is 10 (since the sub-channel/slot combinations indexed as 2, 7, 9, 10, 12, and 13 are excluded from the number of available single-slot resources). As shown by reference number 1310, for single-slot resources identified using the second set of parameters, the number of total single-slot resources is 12 and the number of available single-slot resources is 6. This determination was described in more detail in connection with FIG. 10.

The order may indicate an order in which multi-slot resources (e.g., total and available multi-slot resources) are identified. For example, a first order, shown by reference number 1315, may indicate that a first slot (e.g., for transmission of a first TB) of the multi-slot resource is to be identified in accordance with the first set of parameters (by reference to the available single-slot resources shown by reference number 1305) and a second slot (e.g., for transmission of a second TB) of the multi-slot resource is to be identified in accordance with the second set of parameters (by reference to the available single-slot resources shown by reference number 1310). For example, a second order, shown by reference number 1320, may indicate that a first slot (e.g., for transmission of a first TB) of the multi-slot resource is to be identified in accordance with the second set of parameters (by reference to the available single-slot resources shown by reference number 1310) and a second slot (e.g., for transmission of a second TB) of the multi-slot resource is to be identified in accordance with the first set of parameters (by reference to the available single-slot resources shown by reference number 1305).

If the first order is used, the number of total multi-slot resources may be equal to

$${M}_{t otal} = {C}_{4}^{1} * {C}_{3}^{1} * 3 = 36 .$$

Furthermore, the number of available multi-slot resources may be equal to

$${M}_{available} = {C}_{3}^{1} * {C}_{2}^{1} + {C}_{3}^{1} * {C}_{1}^{1} + {C}_{2}^{1} * {C}_{2}^{1} = 13 .$$

If the second order is used, The number of total multi-slot resources may be equal to

$${M}_{t o t a l} = {C}_{3}^{1} * {C}_{4}^{1} * 3 = 36 ,$$

and the number of available multi-slot resources may be equal to

$${M}_{available} = {C}_{1}^{1} * {C}_{3}^{1} + {C}_{2}^{1} * {C}_{2}^{1} + {C}_{1}^{1} * {C}_{2}^{1} = 9.$$

Taking, as an example, the second order, the number of available multi-slot resources can be determined by: (1) identifying a first number of available multi-slot resources according to available single-slot resources (as determined according to the second set of parameters) in slot 0 and available single-slot resources (as determined according to the first set of parameters) in slot 1, (2) identifying a second number of available multi-slot resources according to available single-slot resources (as determined according to the second set of parameters) in slot 1 and available single-slot resources (as determined according to the first set of parameters) in slot 2, (3) identifying a third number of available multi-slot resources according to available single-slot resources (as determined according to the second set of parameters) in slot 2 and available single-slot resources (as determined according to the first set of parameters) in slot 3, and (4) summing the first number, the second number, and the third number. Note that, according to the number of subchannels (L_{subCH}) of the first set of parameters, an available single-slot resource according to the first set of parameters occupies a single sub-channel, while an available single-slot resource according to the second set of parameters occupies two contiguous sub-channels. Therefore, for example, the second set of parameters indicates one available single-slot resource in slot 0, whereas the first set of parameters indicates three available resources in slot 1 (leading to the first number described above being equal to 1*3=3, since each of the three available single-slot resources in slot 1 can be combined with the available single-slot resource in slot 0).

As indicated above, FIG. 13 is provided as an example. Other examples may differ from what is described with regard to FIG. 13.

In some aspects, the UE may identify more than two sets of parameters. For example, the higher layer of the UE may provide four sets of parameters. In some aspects, the UE may group the multiple sets of parameters into two or more sets of parameters. Each group may include a subset of the multiple sets of parameters. The UE may report available multi-slot resources per group. For example, the reported multi-slot resources across different groups may be independent of one another. Within a group, the UE may determine a resource selection window and RSRP threshold list, and may determine proportions of available multi-slot resources, using the parameters belonging to the group. For example, the UE may divide the four sets of parameters into 2 groups based at least in part on values of one or more parameters in the four sets of parameters (e.g., a first two sets of parameters may belong to a first group and a second two sets of parameters may belong to a second group). The UE may select two groups of candidate multi-slot resources (one for each group). The candidate multi-slot resources in each group may include 2 consecutive single-slot resources in time. This can be compared to the approach in FIGS. 11 and 12, in which the UE may select 4 consecutive single-slot resources in time: one corresponding to each set of parameters.

In some aspects, the groups may be defined based at least in part on a transmission priority. For example, a first set of parameters and a second set of parameters may be assigned to a same group based at least in part on a transmission priority of the first set of parameters and the second set of parameters being with the same priority class. The mapping between the priority class and the transmission priority, e.g., prio_{TX}, can be predefined. For example, a priority class may include one or more priory values. In some aspects, the groups may be defined based at least in part on a remaining PDB. For example, a first set of parameters and a second set of parameters may be assigned to a same group based at least in part on a remaining PDB in the first set of parameters and the second set of parameters being the same. In some aspects, the groups may be defined based at least in part on a number of subchannels. For example, a first set of parameters and a second set of parameters may be assigned to a same group based at least in part on a number of subchannels in the first set of parameters and the second set of parameters being the same. In some aspects, the groups may be defined based at least in part on a reservation periodicity. For example, a first set of parameters and a second set of parameters may be assigned to a same group based at least in part on a reservation periodicity in the first set of parameters and the second set of parameters being the same. In some aspects, the groups may be defined based at least in part on a group index. For example, a first set of parameters and a second set of parameters may be assigned to a same group based at least in part on a group index in the first set of parameters and the second set of parameters being the same, where the group index may be provided by a higher layer of the UE (e.g., as part of the multiple sets of parameters). In some aspects, the group may be defined based on one or more parameters in the first set of parameters and the second set of parameters.

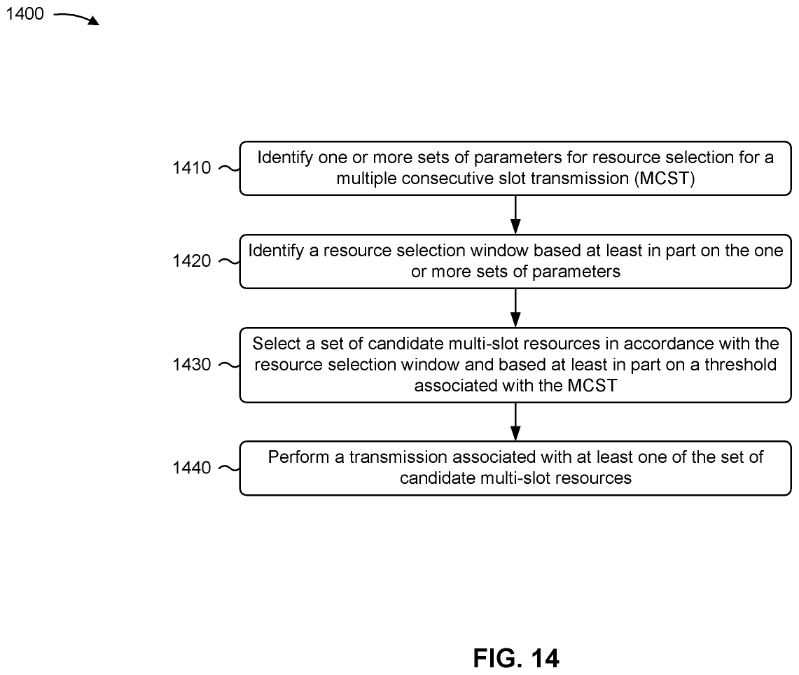

FIG. 14 is a diagram illustrating an example process 1400 performed, for example, by a UE, in accordance with the present disclosure. Example process 1400 is an example where the UE (e.g., UE 120) performs operations associated with techniques for selecting resources for multiple consecutive slot transmission.

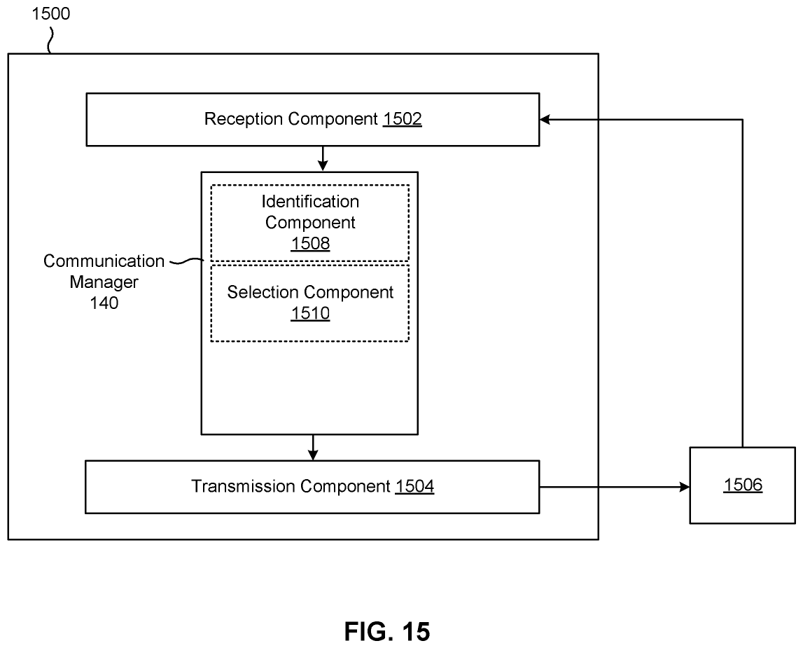

As shown in FIG. 14, in some aspects, process 1400 may include identifying one or more sets of parameters for resource selection for a MCST (block 1410). For example, the UE (e.g., using communication manager 140 and/or identification component 1508, depicted in FIG. 15) may identify one or more sets of parameters for resource selection for an MCST, as described above.

As further shown in FIG. 14, in some aspects, process 1400 may include identifying a resource selection window based at least in part on the one or more sets of parameters (block 1420). For example, the UE (e.g., using communication manager 140 and/or identification component 1508, depicted in FIG. 15) may identify a resource selection window based at least in part on the one or more sets of parameters, as described above.

As further shown in FIG. 14, in some aspects, process 1400 may include selecting a set of candidate multi-slot resources in accordance with the resource selection window and based at least in part on a threshold associated with the MCST (block 1430). For example, the UE (e.g., using communication manager 140 and/or selection component 1510, depicted in FIG. 15) may select a set of candidate multi-slot resources in accordance with the resource selection window and based at least in part on a threshold associated with the MCST, as described above. In some aspects, the UE may report the set of candidate multi-slot resources to a higher layer of the UE. In some aspects, the UE may select, from a reported set of candidate multi-slot resources, multi-slot resources for transmission of an MCST.

As further shown in FIG. 14, in some aspects, process 1400 may include performing a transmission associated with at least one of the set of candidate multi-slot resources (block 1440). For example, the UE (e.g., using communication manager 140 and/or transmission component 1504, depicted in FIG. 15) may perform a transmission (e.g., a transmission of a reservation for a multi-slot resource for an MCST, or a transmission of an MCST) associated with at least one of the set of candidate multi-slot resources, as described above.

Process 1400 may include additional aspects, such as any single aspect or any combination of aspects described below and/or in connection with one or more other processes described elsewhere herein.

In a first aspect, the one or more sets of parameters include a single set of parameters and the selection of the set of candidate multi-slot resources is based at least in part on whether a proportion of available multi-slot resources in the resource selection window satisfies the threshold associated with the MCST.

In a second aspect, alone or in combination with the first aspect, process 1400 includes receiving configuration information indicating the threshold associated with the MCST.

In a third aspect, alone or in combination with one or more of the first and second aspects, process 1400 includes determining whether the proportion of available multi-slot resources in the resource selection window satisfies the threshold after performing resource exclusion.

In a fourth aspect, alone or in combination with one or more of the first through third aspects, the selection of the set of candidate multi-slot resources further comprises determining whether a proportion of available single-slot resources in the resource selection window satisfies another threshold associated with a single slot transmission, and determining whether the proportion of available multi-slot resources in the resource selection window, selected from the available single-slot resources, satisfies the threshold associated with the MCST.

In a fifth aspect, alone or in combination with one or more of the first through fourth aspects, process 1400 includes increasing an RSRP threshold for each reception priority associated with a transmission priority of the single set of parameters based at least in part on the proportion of available multi-slot resources in the resource selection window not satisfying the threshold, and performing resource exclusion for the single set of parameters using the RSRP threshold.

In a sixth aspect, alone or in combination with one or more of the first through fifth aspects, the one or more sets of parameters include a first set of parameters and a second set of parameters.

In a seventh aspect, alone or in combination with one or more of the first through sixth aspects, the identification of the one or more resource selection window based at least in part on the one or more sets of parameters further comprises identifying a first resource selection window for the first set of parameters and a second resource selection window for the second set of parameters.

In an eighth aspect, alone or in combination with one or more of the first through seventh aspects, the identification of the resource selection window based at least in part on the one or more sets of parameters further comprises identifying a single resource selection window for the first set of parameters and the second set of parameters.

In a ninth aspect, alone or in combination with one or more of the first through eighth aspects, a maximum timing difference between an ending time of the resource selection window and a resource selection trigger time is based at least in part on a smallest remaining packet delay budget of the one or more sets of parameters.

In a tenth aspect, alone or in combination with one or more of the first through ninth aspects, a minimum timing difference between an ending time of the resource selection window and a resource selection trigger time is based at least in part on at least one of a minimum timing difference associated with a transmission priority corresponding to the smallest remaining packet delay budget, a minimum timing difference associated with a smallest or largest transmission priority value of the one or more sets of parameters, or a minimum timing difference with a largest value of multiple minimum timing differences associated with the one or more sets of parameters.

In an eleventh aspect, alone or in combination with one or more of the first through tenth aspects, process 1400 includes performing resource exclusion for each of the first set of parameters and the second set of parameters prior to selecting the set of candidate resources, wherein the resource exclusion is based at least in part on a first RSRP threshold list for the first set of parameters and a second RSRP threshold list for the second set of parameters.

In a twelfth aspect, alone or in combination with one or more of the first through eleventh aspects, process 1400 includes performing resource exclusion for each of the first set of parameters and the second set of parameters prior to selecting the set of candidate resources, wherein the resource exclusion is based at least in part on a same RSRP threshold list for the first set of parameters and the second set of parameters.

In a thirteenth aspect, alone or in combination with one or more of the first through twelfth aspects, the selection of the set of candidate multi-slot resources further comprises determining whether a proportion of available multi-slot resources in the identified resource selection window satisfies a threshold associated with the MCST.

In a fourteenth aspect, alone or in combination with one or more of the first through thirteenth aspects, the selection of the set of candidate multi-slot resources further comprises determining whether a proportion of available single-slot resources in the resource selection window satisfies another threshold associated with a single slot transmission, and determining whether a proportion of available multi-slot resources in the resource selection window, selected from the available single-slot resources, satisfies the threshold associated with the MCST.

In a fifteenth aspect, alone or in combination with one or more of the first through fourteenth aspects, process 1400 includes selecting a set of parameters of the first set of parameters or the second set of parameters based at least in part on a rule, increasing an RSRP threshold for each reception priority under the transmission priority in the selected set of parameters based on at least in part on determining that a proportion of available multi-slot resources in the resource selection window does not satisfy the threshold, and performing resource exclusion for the selected set of parameters using the increased RSRP threshold.

In a sixteenth aspect, alone or in combination with one or more of the first through fifteenth aspects, process 1400 includes increasing an RSRP threshold for each reception priority associated with each transmission priority of the first set of parameters and the second set of parameters based on at least in part on determining a proportion of available multi-slot resources in the resource selection window does not satisfy the threshold, and performing resource exclusion separately for the first set of parameters and for the second set of parameters using the increased RSRP thresholds.

In a seventeenth aspect, alone or in combination with one or more of the first through sixteenth aspects, the first set of parameters and the second set of parameters are provided by a higher layer of the UE.

In an eighteenth aspect, alone or in combination with one or more of the first through seventeenth aspects, the first set of parameters and the second set of parameters are a subset of multiple sets of parameters provided by higher layer, wherein the first set of parameters and the second set of parameters are grouped for resource selection of the MCST based at least in part on one or more of the following a transmission priority of the first set of parameters and the second set of parameters being with the same priority class, a remaining packet delay budget in the first set of parameters and the second set of parameters being the same, a number of subchannels in the first set of parameters and the second set of parameters being the same, a reservation periodicity in the first set of parameters and the second set of parameters being the same, or a group index of the first set of parameters and the second set of parameters being the same, wherein the group index is provided by a higher layer of the UE.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of an identification component 1508 or a selection component 1510, among other examples.

In some aspects, the apparatus 1500 may be configured to perform one or more operations described herein in connection with FIGS. 4-13. Additionally, or alternatively, the apparatus 1500 may be configured to perform one or more processes described herein, such as process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The identification component 1508 may identify one or more sets of parameters for resource selection for an MCST. The identification component 1508 may identify a resource selection window based at least in part on the one or more sets of parameters. The selection component 1510 may select a set of candidate multi-slot resources in accordance with the resource selection window and based at least in part on a threshold associated with the MCST. The transmission component 1504 may perform a transmission associated with at least one of the set of candidate multi-slot resources.

The reception component 1502 may receive configuration information indicating the threshold associated with the MCST.

The selection component 1510 may determine whether the proportion of available multi-slot resources in the resource selection window satisfies the threshold after performing resource exclusion.

The identification component 1508 may increase an RSRP threshold for each reception priority associated with a transmission priority of the single set of parameters based at least in part on the proportion of available multi-slot resources in the resource selection window not satisfying the threshold.

The selection component 1510 may perform resource exclusion for the single set of parameters using the RSRP threshold.

The selection component 1510 may perform resource exclusion for each of the first set of parameters and the second set of parameters prior to selecting the set of candidate resources, wherein the resource exclusion is based at least in part on a first RSRP threshold list for the first set of parameters and a second RSRP threshold list for the second set of parameters.

The selection component 1510 may perform resource exclusion for each of the first set of parameters and the second set of parameters prior to selecting the set of candidate resources, wherein the resource exclusion is based at least in part on a same RSRP threshold list for the first set of parameters and the second set of parameters.

The selection component 1510 may select a set of parameters of the first set of parameters or the second set of parameters based at least in part on a rule.

The selection component 1510 may increase an RSRP threshold for each reception priority under the transmission priority in the selected set of parameters based on at least in part on determining that a proportion of available multi-slot resources in the resource selection window does not satisfy the threshold.

The selection component 1510 may perform resource exclusion for the selected set of parameters using the increased RSRP threshold.

The identification component 1508 may increase an RSRP threshold for each reception priority associated with each transmission priority of the first set of parameters and the second set of parameters based on at least in part on determining a proportion of available multi-slot resources in the resource selection window does not satisfy the threshold.

The selection component 1510 may perform resource exclusion separately for the first set of parameters and for the second set of parameters using the increased RSRP thresholds.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: identifying one or more sets of parameters for resource selection for a multiple consecutive slot transmission (MCST); identifying a resource selection window based at least in part on the one or more sets of parameters; selecting a set of candidate multi-slot resources in accordance with the resource selection window and based at least in part on a threshold associated with the MCST; and performing a transmission associated with at least one of the set of candidate multi-slot resources.

Aspect 2: The method of Aspect 1, wherein the one or more sets of parameters include a single set of parameters and the selection of the set of candidate multi-slot resources is based at least in part on whether a proportion of available multi-slot resources in the resource selection window satisfies the threshold associated with the MCST.

Aspect 3: The method of Aspect 1, further comprising receiving configuration information indicating the threshold associated with the MCST.

Aspect 4: The method of Aspect 2, further comprising performing resource exclusion for the single set of parameters, wherein the selection of the set of candidate resources further comprises determining whether the proportion of available multi-slot resources in the resource selection window satisfies the threshold after performing resource exclusion.

Aspect 5: The method of Aspect 2, wherein the selection of the set of candidate multi-slot resources further comprises: determining whether a proportion of available single-slot resources in the resource selection window satisfies another threshold associated with a single slot transmission; and determining whether the proportion of available multi-slot resources in the resource selection window, selected from the available single-slot resources, satisfies the threshold associated with the MCST.

Aspect 6: The method of Aspect 2, further comprises: increasing an RSRP threshold for each reception priority associated with a transmission priority of the single set of parameters based at least in part on the proportion of available multi-slot resources in the resource selection window not satisfying the threshold; and performing resource exclusion for the single set of parameters using the RSRP threshold.

Aspect 7: The method of any of Aspects 1-6, wherein the one or more sets of parameters include a first set of parameters and a second set of parameters.

Aspect 8: The method of Aspect 7, wherein the identification of the one or more resource selection window based at least in part on the one or more sets of parameters further comprises identifying a first resource selection window for the first set of parameters and a second resource selection window for the second set of parameters.

Aspect 9: The method of Aspect 7, wherein the identification of the resource selection window based at least in part on the one or more sets of parameters further comprises identifying a single resource selection window for the first set of parameters and the second set of parameters.

Aspect 10: The method of Aspect 9, wherein a maximum timing difference between an ending time of the resource selection window and a resource selection trigger time is based at least in part on a smallest remaining packet delay budget of the one or more sets of parameters.

Aspect 11: The method of Aspect 9, wherein a minimum timing difference between an ending time of the resource selection window and a resource selection trigger time is based at least in part on at least one of: a minimum timing difference associated with a transmission priority corresponding to the smallest remaining packet delay budget, a minimum timing difference associated with a smallest or largest transmission priority value of the one or more sets of parameters, or a minimum timing difference with a largest value of multiple minimum timing differences associated with the one or more sets of parameters.

Aspect 12: The method of Aspect 7, further comprising performing resource exclusion for each of the first set of parameters and the second set of parameters prior to selecting the set of candidate resources, wherein the resource exclusion is based at least in part on a first RSRP threshold list for the first set of parameters and a second RSRP threshold list for the second set of parameters.

Aspect 13: The method of Aspect 7, further comprising performing resource exclusion for each of the first set of parameters and the second set of parameters prior to selecting the set of candidate resources, wherein the resource exclusion is based at least in part on a same RSRP threshold list for the first set of parameters and the second set of parameters.

Aspect 14: The method of Aspect 7, wherein the selection of the set of candidate multi-slot resources further comprises determining whether a proportion of available multi-slot resources in the identified resource selection window satisfies a threshold associated with the MCST.

Aspect 15: The method of Aspect 7, wherein the selection of the set of candidate multi-slot resources further comprises: determining whether a proportion of available single-slot resources in the resource selection window satisfies another threshold associated with a single slot transmission; and determining whether a proportion of available multi-slot resources in the resource selection window, selected from the available single-slot resources, satisfies the threshold associated with the MCST.

Aspect 16: The method of Aspect 7, further comprising: selecting a set of parameters of the first set of parameters or the second set of parameters based at least in part on a rule; increasing an RSRP threshold for each reception priority under the transmission priority in the selected set of parameters based on at least in part on determining that a proportion of available multi-slot resources in the resource selection window does not satisfy the threshold; and performing resource exclusion for the selected set of parameters using the increased RSRP threshold.

Aspect 17: The method of Aspect 7, further comprising: increasing an RSRP threshold for each reception priority associated with each transmission priority of the first set of parameters and the second set of parameters based on at least in part on determining a proportion of available multi-slot resources in the resource selection window does not satisfy the threshold; and performing resource exclusion separately for the first set of parameters and for the second set of parameters using the increased RSRP thresholds.

Aspect 18: The method of Aspect 7, wherein the first set of parameters and the second set of parameters are provided by a higher layer of the UE.

Aspect 19: The method of Aspect 7, wherein the first set of parameters and the second set of parameters are a subset of multiple sets of parameters provided by higher layer, wherein the first set of parameters and the second set of parameters are grouped for resource selection of the MCST based at least in part on one or more of the following: a transmission priority of the first set of parameters and the second set of parameters being with the same priority class, a remaining packet delay budget in the first set of parameters and the second set of parameters being the same, a number of subchannels in the first set of parameters and the second set of parameters being the same, a reservation periodicity in the first set of parameters and the second set of parameters being the same, or a group index of the first set of parameters and the second set of parameters being the same, wherein the group index is provided by a higher layer of the UE.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1.-19. (canceled)

20. A method of wireless communication performed by a user equipment (UE), comprising:
identifying one or more sets of parameters for resource selection for a multiple consecutive slot transmission (MCST);
identifying a resource selection window based at least in part on the one or more sets of parameters;
selecting a set of candidate multi-slot resources in accordance with the resource selection window and based at least in part on a threshold associated with the MCST; and
performing a transmission associated with at least one of the set of candidate multi-slot resources.

21. The method of claim 20, wherein the one or more sets of parameters include a single set of parameters and the selection of the set of candidate multi-slot resources is based at least in part on whether a proportion of available multi-slot resources in the resource selection window satisfies the threshold associated with the MCST.

22. The method of claim 21, further comprising performing resource exclusion for the single set of parameters, wherein the selection of the set of candidate resources further comprises determining whether the proportion of available multi-slot resources in the resource selection window satisfies the threshold after performing resource exclusion.

23. The method of claim 21, wherein the selection of the set of candidate multi-slot resources further comprises:
determining whether a proportion of available single-slot resources in the resource selection window satisfies another threshold associated with a single slot transmission; and
determining whether the proportion of available multi-slot resources in the resource selection window, selected from the available single-slot resources, satisfies the threshold associated with the MCST.

24. The method of claim 21, further comprises:
increasing an RSRP threshold for each reception priority associated with a transmission priority of the single set of parameters based at least in part on the proportion of available multi-slot resources in the resource selection window not satisfying the threshold; and
performing resource exclusion for the single set of parameters using the RSRP threshold.

25. The method of claim 20, further comprising receiving configuration information indicating the threshold associated with the MCST.

26. The method of claim 20, wherein the one or more sets of parameters include a first set of parameters and a second set of parameters.

27. The method of claim 26, wherein the identification of the resource selection window based at least in part on the one or more sets of parameters further comprises identifying a first resource selection window for the first set of parameters and a second resource selection window for the second set of parameters.

28. The method of claim 26, wherein the identification of the resource selection window based at least in part on the one or more sets of parameters further comprises identifying a single resource selection window for the first set of parameters and the second set of parameters.

29. The method of claim 28, wherein a maximum timing difference between an ending time of the resource selection window and a resource selection trigger time is based at least in part on a smallest remaining packet delay budget of the one or more sets of parameters.

30. The method of claim 28, wherein a minimum timing difference between an ending time of the resource selection window and a resource selection trigger time is based at least in part on at least one of:
a minimum timing difference associated with a transmission priority corresponding to a smallest remaining packet delay budget,
a minimum timing difference associated with a smallest or largest transmission priority value of the one or more sets of parameters, or
a minimum timing difference with a largest value of multiple minimum timing differences associated with the one or more sets of parameters.

31. The method of claim 26, further comprising performing resource exclusion for each of the first set of parameters and the second set of parameters prior to selecting the set of candidate resources, wherein the resource exclusion is based at least in part on a first RSRP threshold list for the first set of parameters and a second RSRP threshold list for the second set of parameters.

32. The method of claim 26, further comprising performing resource exclusion for each of the first set of parameters and the second set of parameters prior to selecting the set of candidate resources, wherein the resource exclusion is based at least in part on a same RSRP threshold list for the first set of parameters and the second set of parameters.

33. The method of claim 26, wherein the selection of the set of candidate multi-slot resources further comprises determining whether a proportion of available multi-slot resources in the identified resource selection window satisfies the threshold associated with the MCST.

34. The method of claim 26, wherein the selection of the set of candidate multi-slot resources further comprises:
determining whether a proportion of available single-slot resources in the resource selection window satisfies another threshold associated with a single slot transmission; and
determining whether a proportion of available multi-slot resources in the resource selection window, selected from the available single-slot resources, satisfies the threshold associated with the MCST.

35. The method of claim 26, further comprising:
selecting a set of parameters of the first set of parameters or the second set of parameters based at least in part on a rule;
increasing an RSRP threshold for each reception priority under a transmission priority of the selected set of parameters based on at least in part on determining that a proportion of available multi-slot resources in the resource selection window does not satisfy the threshold; and
performing resource exclusion for the selected set of parameters using the increased RSRP threshold.

36. The method of claim 26, further comprising:
increasing an RSRP threshold for each reception priority associated with each transmission priority of the first set of parameters and the second set of parameters based on at least in part on determining a proportion of available multi-slot resources in the resource selection window does not satisfy the threshold; and
performing resource exclusion separately for the first set of parameters and for the second set of parameters using the increased RSRP thresholds.

37. The method of claim 26, wherein the first set of parameters and the second set of parameters are provided by a higher layer of the UE.

38. The method of claim 26, wherein the first set of parameters and the second set of parameters are a subset of multiple sets of parameters provided by higher layer, wherein the first set of parameters and the second set of parameters are grouped for resource selection of the MCST based at least in part on one or more of the following:
a transmission priority of the first set of parameters and the second set of parameters being with the same priority class,
a remaining packet delay budget in the first set of parameters and the second set of parameters being the same,
a number of subchannels in the first set of parameters and the second set of parameters being the same,
a reservation periodicity in the first set of parameters and the second set of parameters being the same, or
a group index of the first set of parameters and the second set of parameters being the same, wherein the group index is provided by a higher layer of the UE.

39. A non-transitory computer-readable medium storing a set of instructions for wireless communication, the set of instructions comprising:
one or more instructions that, when executed by one or more processors of a user equipment (UE), cause the UE to:
identify one or more sets of parameters for resource selection for a multiple consecutive slot transmission (MCST);
identify a resource selection window based at least in part on the one or more sets of parameters;
select a set of candidate multi-slot resources in accordance with the resource selection window and based at least in part on a threshold associated with the MCST; and
perform a transmission associated with at least one of the set of candidate multi-slot resources.

40. An apparatus for wireless communication, comprising:
means for identifying one or more sets of parameters for resource selection for a multiple consecutive slot transmission (MCST);
means for identifying a resource selection window based at least in part on the one or more sets of parameters;
means for selecting a set of candidate multi-slot resources in accordance with the resource selection window and based at least in part on a threshold associated with the MCST; and
means for performing a transmission associated with at least one of the set of candidate multi-slot resources.
